(19) United States
(12) Patent Application Publication
(10) Pub. No.: US 2019/0279211 A1
(43) Pub. Date: Sep. 12, 2019

(54) ONE-TIME PASSWORD PROCESSING SYSTEMS AND METHODS

(71) Applicant: Mastercard International Incorporated, Purchase, NY (US)

(72) Inventors: Ashish Goyal, Bathinda (IN); Jaipal Singh Kumawat, Sikar (IN); Komalpreet Kaur, New Delhi (IN)

(21) Appl. No.: 16/287,352

(22) Filed: Feb. 27, 2019

(30) Foreign Application Priority Data
Mar. 9, 2018 (SG) 10201801990P

(51) Int. Cl. G06Q 20/40; G06Q 20/38; H04L 29/06

(52) U.S. Cl. CPC G06Q 20/407; H04L 63/0838; G06Q 20/385; G06Q 20/401

(57) ABSTRACT

A data processing system for authenticating a user with a one-time password is disclosed. The data processing system comprises: a computer processor and a data storage device, the data storage device storing instructions operative by the processor to: receive a transaction authorization request for a transaction, the transaction authorization request comprising a payment card identifier indicating a payment card associated the transaction; look up contact information for a user associated with the payment card using the payment card identifier; generate a one-time password indication, the one-time password indication comprising a one-time password; send the one-time password indication to the user using the contact information for the user; receive an anomalous one-time password alert indication from the user; and generate a transaction authorization response blocking the transaction.

### CROSS-REFERENCE TO RELATED APPLICATION

This application is a U.S. National Stage filing under 35 U.S.C. § 119, based on and claiming benefits of and priority to Singapore Patent Application No. 10201801990P filed on Mar. 9, 2018. The entire disclosure of the above application is incorporated herein by reference for all purposes.

### FIELD OF THE INVENTION

The present disclosure relates to systems and methods for processing one-time passwords and in particular to allowing a user to cancel a transaction in response to receiving a one-time password indication.

### BACKGROUND OF THE INVENTION

One-time passwords (OTPs) are often used in the verification of payment transactions, and particularly in card not present transaction such as website based electronic commerce transactions. In the transaction authorization process for a purchase at an on-line merchant, an OTP is sent as a text message, email message or other type of electronic communication to a stored telephone number or other contact information stored for the customer and linked to a payment card. In order to verify that the transaction originated with the true cardholder, the customer is prompted to enter the OTP. Thus the use of OTPs can prevent or reduce fraudulent use of stolen or cloned payment cards since in order for a transaction to be approved, the user must have access to the mobile telephone, email account or other electronic communication account of the cardholder.

However, if a fraudulent user is able to obtain access to a cardholder's mobile telephone, email account or other communication account then the fraudulent user is able to obtain the OTP. Many OTP systems provide a time limit in which an OTP is valid, for example 180 seconds, after which a transaction cannot be authorized without generating a new OTP. However, current systems do not provide a way for a cardholder to pro-actively cancel a fraudulent OTP request. If a customer receives an unrequested OTP, currently they would have to contact the card issuer, for example through a telephone call to a helpline, however this process is cumbersome and time consuming.

### SUMMARY OF THE INVENTION

In accordance with a first aspect of the present invention there is provided a data processing system for authenticating a user with a one-time password. The data processing system comprises: a computer processor and a data storage device, the data storage device storing instructions operative by the processor to: receive a transaction authorization request for a transaction, the transaction authorization request comprising a payment card identifier indicating a payment card associated the transaction; look up contact information for a user associated with the payment card using the payment card identifier; generate a one-time password indication, the one-time password indication comprising a one-time password; send the one-time password indication to the user using the contact information for the user; receive an anomalous one-time password alert indication from the user; and generate a transaction authorization response blocking the transaction.

In an embodiment, the one-time password indication comprises an alert prompt indicating how to send an anomalous one-time password alert indication in response to the one-time password indication.

In an embodiment, the one-time password indication comprises a message sent to a device associated with the user and the anomalous one-time password alert indication comprises a reply to the message.

In an embodiment, the data storage device stores instructions operative by the processor to wait a delay period after sending the one-time password to the user.

In an embodiment, the data storage device stores instructions operative by the processor to generate a payment card lock request in response to receiving the anomalous one-time password alert indication.

In an embodiment, the payment card lock request comprises a request to lock the payment card for a period of time.

In an embodiment, the payment transaction authorization request further comprises transaction information, the one-time password indication further comprising at least part of the transaction information.

In an embodiment, the transaction information comprises: a merchant identifier, and/or a transaction type indicator, and/or a transaction amount indicator.

In an embodiment, the contact information for the user comprises contact details for at least two messaging types data storage device stores instructions operative by the processor to send the one-time password indication to the user on multiple messaging types using the contact information for the user.

According to a second aspect of the present invention there is provided a one-time password processing method comprising: receiving a transaction authorization request for a transaction, the transaction authorization request comprising a payment card identifier indicating a payment card associated the transaction; looking up contact information for a user associated with the payment card using the payment card identifier; generating a one-time password indication, the one-time password indication comprising a one-time password; sending the one-time password indication to the user using the contact information for the user; receiving an anomalous one-time password alert indication from the user; and generating a transaction authorization response blocking the transaction.

Embodiments of the invention may be implemented as a network of communicating devices (i.e. a “computerized network”). Further embodiments comprise a software application downloadable into a computer device to facilitate the method. The software application may be a computer program product, which may be stored on a non-transitory computer-readable medium on a tangible data-storage device (such as a storage device of a server, or one within a user device).

### BRIEF DESCRIPTION OF THE DRAWINGS

Embodiments of the invention will now be described by way of example only with reference to the following drawings, in which:

FIG. 1 is a block diagram showing a system for processing one-time passwords according to an embodiment of the present invention;

FIG. 2 is a block diagram showing functional modules of a one-time password processing server according to an embodiment of the present invention;

FIG. 3 is a flow chart showing a method of processing a one-time password according to an embodiment of the present invention;

FIG. 4 is shows an example one-time password message according to an embodiment of the present invention; and

FIG. 5 is a block diagram showing a technical architecture of a one-time password processing server according to an embodiment of the present invention.

### DETAILED DESCRIPTION OF CERTAIN EMBODIMENTS

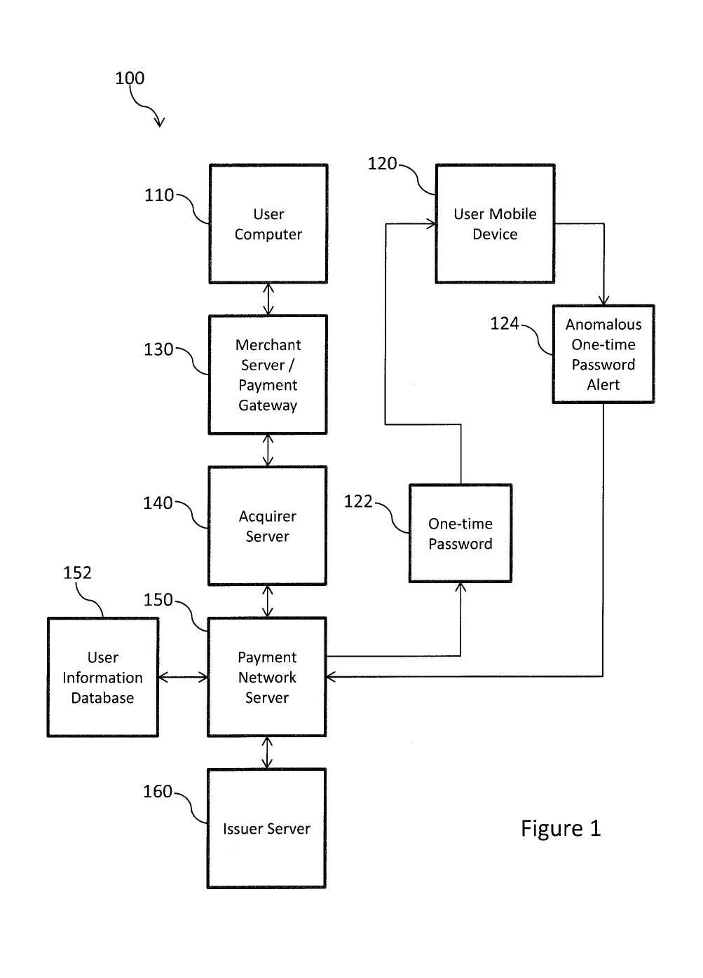

FIG. 1 is a block diagram showing a system for processing one-time passwords according to an embodiment of the present invention. As shown in FIG. 1, the system comprises a user computer 110 which is used by a cardholder of a payment card to access an electronic commerce website. The electronic commerce website is provided by a merchant server 130. The merchant server 130 provides the user with a checkout functionality into which the user enters their payment card details once a selection of goods for purchase has been finalized. In some embodiments, the entry and processing of payment card information may be provided by a payment gateway. The merchant server or payment gateway is coupled to an acquirer server 140 which is associated with an acquirer bank or financial organization which provides an account for the merchant. The acquirer server 140 is coupled to a payment network server 150. The payment network server 150 forms part of a payment network such as the Banknet payment network provided by Mastercard.

An issuer server 160 which is associated with a bank or financial organization which issues payment cards is coupled to the payment network server 160. A user information database 152 forms part of the payment network and is coupled to the payment network server 150. The user information database 152 stores contact information such as mobile telephone numbers, email addresses, social media identifiers, and messaging identifiers associated with cardholders of payment cards. This information is used by the payment network server 150 to determine a destination for a one-time password (OTP) generated during the authorization of a payment card transaction.

As shown in FIG. 1, the user has a user mobile device 120 and payment network server 150 sends an OTP 122 to the user mobile device 120 during the authorization of payment card transactions. As shown in FIG. 1, the user may send an anomalous one-time password alert 124 to the payment network server 150 to indicate that a suspicious or unexpected OTP was received. The nature and processing of the anomalous one-time password alert 124 is described in more detail below.

The flow of a typical transaction authorization request and response will now be described with reference to FIG. 1. Initially, the user accesses an electronic commerce website provided by the merchant server 130 and makes a selection of items to purchase. Once the user has completed the selection they select a “check-out” option and enter payment details and other information such as delivery details. In some embodiments, the payment details entry may be provided by a payment gateway.

In response to the cardholder entering payment card details into a form provided by the merchant server/payment gateway 130, a payment transaction request is generated. This payment transaction request is sent to the acquirer server 140. The acquirer server 140 generates a payment transaction authorization request to authorize a payment for the amount of the transaction from the card holder's account held with the payment card issuer to the merchant's account held with the acquirer institution. The acquirer server 140 sends the payment transaction authorization request to the payment network server 150. The payment network server 150 identifies the payment transaction authorization request as relating to an electronic commerce transaction and as a result of this determines that one-time password verification is required. The payment network server 150 uses user information database 152 to look up contact information for the payment card holder. This look up of contact information may involve using the payment card identifier to find contact details such as a mobile telephone number for the card holder.

Here is it noted that cardholders may be requested to register their payment cards and to enter contact details such as a mobile telephone number, an email address or other identifier such as social media or messaging application identifier. This information is then stored in the user information database 152 for use in OTP verification.

Following looking up the contact details in the user information database 152, the payment network server 150 sends an OTP input request to the merchant server/payment gateway 130. The OTP prompt is a request to the merchant server/payment gateway 130 to request an OTP from the user. At approximately the same time, the payment network server 150 sends an OTP 122 to the user mobile device 120.

During a normal transaction flow, the user reads the OTP from the mobile device 120 and enters the OTP into a space or form displayed on the user computer 110 as part of a website provided by the merchant server/payment gateway 130. The merchant server/payment gateway 130 sends an indication of the received OTP to the payment network server 150 which compares the received OTP with the OTP 122 send to the user mobile device 120. If there is a match, the transaction authorization request is routed to the issuer server 160 for authorization. If the is no match then an error indication is returned to the merchant server/payment gateway 130, the error indication showing that there was no match is displayed to the user on the user computer 110. In such a scenario, the user may be provided with an option to request a second OTP is sent to the user mobile device 120.

In the event that there is a match, the issuer server 160 receives the payment authorization request which may include an indication of the successful OTP verification and determines whether to authorize the transaction which may comprise determining if there is sufficient balance or credit limit for the payment card account. The issuer server 160 generates an authorization response which indicates the result of the authorization. The authorization response is sent to the payment network server 150 which routes the authorization response to the acquirer server 140. The acquirer server 140 sends a payment transaction response to the merchant server/payment gateway 130 which provides an indication that the transaction has been successful to the user. The merchant server then also begins the process of executing the order by the user, for example sending an indication to a fulfillment department or warehouse to begin to prepare the ordered items.

If a fraudulent user attempts to make a transaction, for example using a stolen or cloned payment card, the following takes place. The steps up to and including the generation of the OTP 122 are as described above, and thus an OTP 122 for a transaction is sent to the user mobile device 120. Thus the user receives an OTP for a transaction that they did not initiate as it is a fraudulent transaction. In response to receiving the OTP 122, the user sends an anomalous one-time password alert 124 to the payment network server 150. In response to receiving the anomalous one-time password alert 124, the payment network server 150 blocks the transaction for which the OTP 122 was generated and may also lock the account associated with the payment card. The nature of the OTP 122 and the anomalous one-time password alert 124 are described in more detail below.

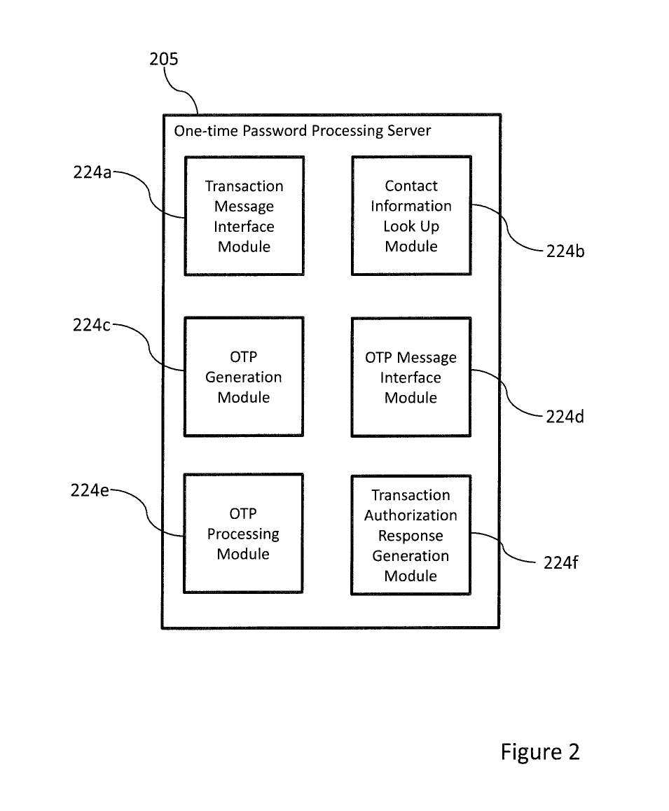

FIG. 2 is a block diagram showing the functional modules of a one-time password processing server according to an embodiment of the present invention. The one-time password processing server 202 may correspond to the payment network server 150 described above in relation to FIG. 1. However, it should be appreciated that the functions of the one-time password processing server 205 may be implemented on other parts of the system 100 shown in FIG. 1, for example, the issuer server 160 may carry out the OTP verification. Further, the functionality of the one-time password server 205 may also be implemented in other systems, for example systems for authorizing automated teller machine (ATM) transactions.

The one-time password processing server 205 comprises a transaction message interface module 224a, a contact information look up module 224b, a one-time password generation module 224c, a one-time password message interface module 224d one-time password processing module 224e and a transaction authorization response generation module 224f. The transaction message interface module 224a is a messaging interface which is coupled to a payment network or other network which allows the one-time password processing server 205 to send and receive transaction related messages from other servers involved in the transaction authorization process. The contact information look up module 224b is coupled to the user information database 152 and is operable to look up contact information, such as a mobile telephone number or email address for a cardholder using a payment card identifier. The one-time password generation module 224c is operable to generate one-time passwords, for example as a random sequence of characters. The one-time password message interface module 224d is a communication module connected to a communication network such as a mobile telephone network or the internet which allows the one-time password processing server 205 to send and receive messages such as text messages and/or email messages. The one-time password processing module 224e performs the verification of user entered OTPs by comparing the user entered OTP with an OTP send to the user device. The Transaction authorization response generation module 224f is operable to generate transaction authorization responses which indicate the results of the OTP verification or the receipt of an anomalous OTP alert indication.

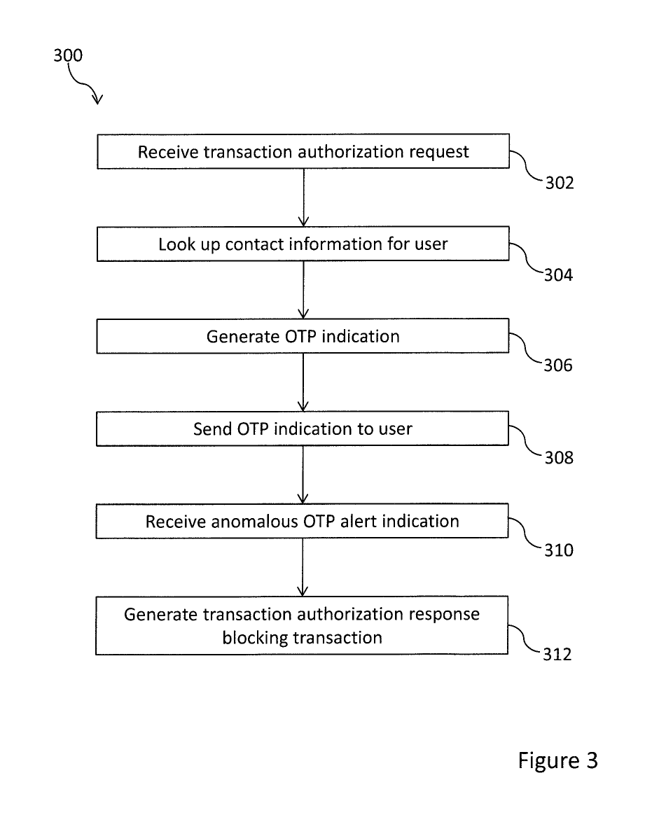

FIG. 3 is a flow chart showing a method of processing a one-time password according to an embodiment of the present invention. The method 300 shown in FIG. 3 is carried out by the one-time password processing server 205 shown in FIG. 2.

In step 302, the transaction message interface module 224a of the one-time password processing server 205 receives a transaction authorization request. The transaction authorization request may be received from an acquirer server 140 as shown in FIG. 1. The transaction authorization request comprises an indication of a payment card account, and information of a transaction comprising an indication of a transaction amount and information identifying a merchant at which the transaction was initiated.

In step 304, the contact information look up module 224b of the one-time password processing server 205 uses the indication of the payment card account from the transaction authorization request to look up contact details for the cardholder. The contact details may comprise a mobile telephone number, an email address, a social media messaging identifier or other messaging type identifier. The contact details may comprise more than one type of messaging identifier, for example both a mobile telephone number and an email address for the user.

In step 306, the OTP generation module 224c of the one-time password processing server 205 generates an OTP indication to be sent to the user. Step 306 comprises generating the one-time password which may comprise a random sequence of characters. The OTP may be, for example a 6-digit number, alternatively, the OTP may be a string of characters. Step 306 may comprise generating more than one OTP indication using the generated OTP, for example, if more than one type of messaging identifier for the user is available, one OTP indication for each messaging type can be generated. It is noted that the OTP indications for different messaging types would all include the same OTP. SO, for example the user may be sent an OTP indication by text message and an OTP indication by email both including the same OTP.

It is noted that sending multiple OTP indications through different messaging types can be particularly advantageous as even if one of these messaging types has been compromised, for example if a user's mobile telephone has been stolen, or if access to the user's email account has been fraudulently gained, the OTP indication will also be sent via the second messaging type and therefore the likelihood that the user will receive at least one of the OTP notifications is increased. Thus the user is more likely to be alerted to fraudulently generated OTP requests.

In step 308, the OTP notification is sent to the user by the OTP messaging interface module 224d of the one-time password processing server 205. As mentioned above, in some embodiments, multiple OTP indications may be sent to the user through different messaging types.

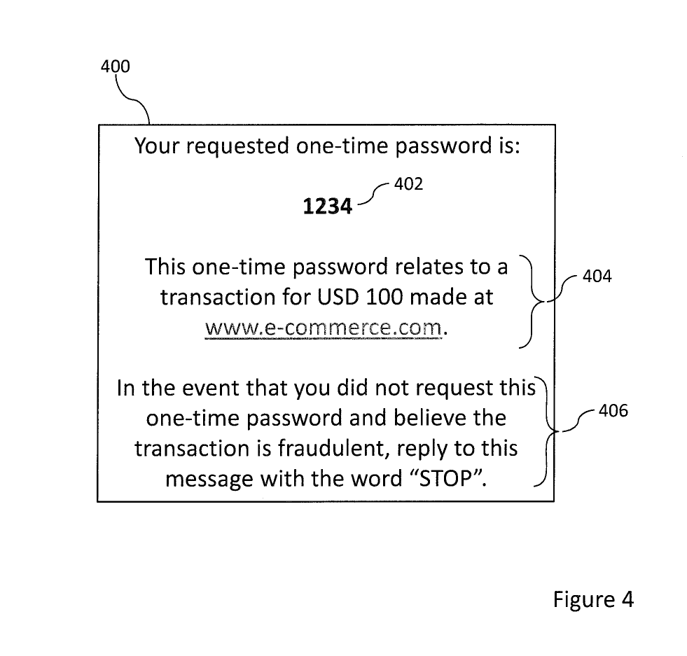

FIG. 4 is shows an example one-time password message according to an embodiment of the present invention. The one-time password message 400 may be sent as a text message and/or as an email message. As shown in FIG. 4, the one-time password message 400 comprises an indication of the OTP 402, which in this example is a 4-digit number “1234”. The one-time password message 400 further comprises an indication of transaction details 404 which may be determined from the transaction authorization request. In this example the indication of transaction details comprises an indication of the transaction amount and an indication of the merchant at which the transaction was initiated. The one-time password message 400 further comprises an indication of how to send an anomalous one-time password alert indication 406. In this case, the user can send an anomalous one-time password alert indication by replying to the OTP message with the word “STOP”. In other embodiments, the anomalous one-time password alert indication may be sent by simply replying to the OTP message.

Returning now to FIG. 3, in some embodiments, the one-time password processing server 205 may delay further processing for a time period after sending the OTP message, of for example 30 seconds, to allow time for the user to respond with an anomalous one-time password response.

In step 310, the OTP message interface module 224d of the one-time password processing server 205 receives an anomalous one-time password alert indication from the user device. As described above in relation to FIG. 4, the anomalous one-time password alert indication is a response to the OTP message and may contain a specific word indicting that the OTP request was fraudulent.

In step 312, the transaction authorization response generation module 224f generates a transaction authorization response which blocks the transaction for which the OTP was requested. In some embodiment, in addition to blocking the transaction, the transaction authorization response generation module 224f may also generate a message which adds the payment card to a hot list indicating that the suspected fraudulent transaction has been attempted using the payment card. In some embodiments, the payment card may be temporality locked for a time period. These indications may be included as flags in the transaction authorization response. In some embodiments, the one-time password processing server 205 also generates a message which is sent to the user mobile device 120 which notifies the user that the payment card has been locked.

In the event that no anomalous one-time password alert indication is received, the OTP processing module 224e of the one-time password processing server 205 requests an indication of the OTP to be entered by the user and then compares the user entered OTP with the stored OTP. If there is a match, the transaction authorization response generation module generates a transaction authorization response message indicating that the OTP verification has taken place.

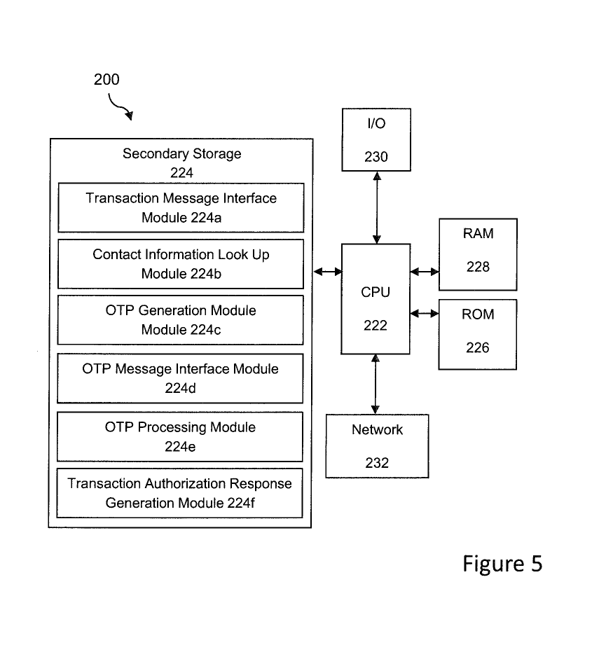

FIG. 5 is a block diagram showing a technical architecture of a one-time password processing server according to an embodiment of the present invention. The technical architecture 200 of one-time password processing server 205 is for performing steps of exemplary methods described above. Typically, the methods are implemented by a number of computers each having a data-processing unit. The block diagram as shown in FIG. 5 illustrates a technical architecture 200 of a computer which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a transaction message interface module 224a, a contact information look up module 224b, a one-time password generation module 224c, a one-time password message interface module 224d, a one-time password processing module 224e, and a transaction authorization response generation module 224f comprising non-transitory instructions operative by the processor 222 to perform various operations of the method of the present disclosure. As depicted in FIG. 5, the modules 224a-224f are distinct modules which perform respective functions implemented by the one-time password processing server 205. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 224a-224f is described herein, these may alternatively be implemented as one or more hardware modules (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the method operations described herein. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

Whilst the foregoing description has described exemplary embodiments, it will be understood by those skilled in the art that many variations of the embodiments can be made in accordance with the appended claims.

1. A data processing system for authenticating a user with a one-time password, the data processing system comprising:
a computer processor and a data storage device, the data storage device storing instructions operative by the processor to:
receive a transaction authorization request for a transaction, the transaction authorization request comprising a payment card identifier indicating a payment card associated the transaction;
look up contact information for a user associated with the payment card using the payment card identifier;
generate a one-time password indication, the one-time password indication comprising a one-time password;
send the one-time password indication to the user using the contact information for the user;
receive an anomalous one-time password alert indication from the user; and
generate a transaction authorization response blocking the transaction.

2. A data processing system according to claim 1, wherein the one-time password indication comprises an alert prompt indicating how to send an anomalous one-time password alert indication in response to the one-time password indication.

3. A data processing system according to claim 1, wherein the one-time password indication comprises a message sent to a device associated with the user and the anomalous one-time password alert indication comprises a reply to the message.

4. A data processing system according to claim 1, wherein the data storage device stores instructions operative by the processor to wait a delay period after sending the one-time password to the user.

5. A data processing system according to claim 1, wherein the data storage device stores instructions operative by the processor to generate a payment card lock request in response to receiving the anomalous one-time password alert indication.

6. A data processing system according to claim 5, wherein the payment card lock request comprises a request to lock the payment card for a period of time.

7. A data processing system according to claim 1, wherein the payment transaction authorization request further comprises transaction information, the one-time password indication further comprising at least part of the transaction information.

8. A data processing system according to claim 7, wherein the transaction information comprises: a merchant identifier, and/or a transaction type indicator, and/or a transaction amount indicator.

9. A data processing system according to claim 1, wherein the contact information for the user comprises contact details for at least two messaging types data storage device stores instructions operative by the processor to send the one-time password indication to the user on multiple messaging types using the contact information for the user.

10. A one-time password processing method comprising:
receiving a transaction authorization request for a transaction, the transaction authorization request comprising a payment card identifier indicating a payment card associated the transaction;
looking up contact information for a user associated with the payment card using the payment card identifier;
generating a one-time password indication, the one-time password indication comprising a one-time password;
sending the one-time password indication to the user using the contact information for the user;
receiving an anomalous one-time password alert indication from the user; and
generating a transaction authorization response blocking the transaction.

11. A method according to claim 10, wherein the one-time password indication comprises an alert prompt indicating how to send an anomalous one-time password alert indication in response to the one-time password indication.

12. A method according to claim 10, wherein the one-time password indication comprises a message sent to a device associated with the user and the anomalous one-time password alert indication comprises a reply to the message.

13. A method according to claim 10, further comprising waiting for a delay period after sending the one-time password to the user.

14. A method according to claim 10, further comprising generating a payment card lock request in response to receiving the anomalous one-time password alert indication.

15. A data processing system according to claim 14, wherein the payment card lock request comprises a request to lock the payment card for a period of time.

16. A method according to claim 10, wherein the payment transaction authorization request further comprises transaction information, the one-time password indication further comprising at least part of the transaction information.

17. A method according to claim 16, wherein the transaction information comprises: a merchant identifier, and/or a transaction type indicator, and/or a transaction amount indicator.

18. A method according to claim 10, wherein the contact information for the user comprises contact details for at least two messaging types and the method comprises sending the one-time password indication to the user on multiple messaging types using the contact information for the user.

19. A non-transitory computer readable medium carrying computer executable instructions which when executed on at least one processor cause the at least one processor to carry out a one-time password processing method comprising:
receiving a transaction authorization request for a transaction, the transaction authorization request comprising a payment card identifier indicating a payment card associated the transaction;
looking up contact information for a user associated with the payment card using the payment card identifier;
generating a one-time password indication, the one-time password indication comprising a one-time password;
sending the one-time password indication to the user using the contact information for the user;
receiving an anomalous one-time password alert indication from the user; and
generating a transaction authorization response blocking the transaction.
